(19) United States
(12) Patent Application Publication
(10) Pub. No.: US 2016/0119887 A1
(43) Pub. Date: Apr. 28, 2016

(54) SIGNAL PROCESSING METHOD FOR UPLINK IN SMALL CELL BASE STATION

(71) Applicants: Gopikrishna Charipadi, Bangalore (IN); Ankush Jain, Indore (IN); Maneesh Gupta, Faridabad (IN); Saurabh Mishra, Delhi (IN)

(72) Inventors: Gopikrishna Charipadi, Bangalore (IN); Ankush Jain, Indore (IN); Maneesh Gupta, Faridabad (IN); Saurabh Mishra, Delhi (IN)

(73) Assignee: Freescale Semiconductor, Inc., Austin, TX (US)

(21) Appl. No.: 14/523,957

(22) Filed: Oct. 27, 2014

(51) Int. Cl. H04W 56/00; H04W 74/00; H04J 13/22; H04W 72/08; H04J 13/18; H04J 13/00; H04W 74/08; H04W 72/04

(52) U.S. Cl. CPC H04W 56/001; H04W 74/0833; H04W 74/008; H04W 72/0446; H04W 72/082; H04J 13/18; H04J 13/0062; H04J 13/22; H04J 2013/0096

(57) ABSTRACT

A base station and method of synchronizing with a user equipment (UE) in a cell of the base station. The base station signals to the UE an indication relating to a subset of preambles chosen for synchronization with the cell from a set of preambles derivable from one or more given root sequences. The subset of preambles is chosen to provide an increased cell radius compared to the cell radius achievable if the specified full set of preambles for random access procedures was generated from the given root sequences using a given cyclic shift value.

### BACKGROUND

The present invention relates generally to wireless communications between user equipment and base stations and, more particularly, to signaling and signal processing for uplink in small cell base stations.

Wireless mobile or cellular networks in which a mobile terminal or User Equipment (UE, such as a smart phone) communicates with a base station of a network of base stations via a radio link are now widely used. The base stations provide radio access nodes in the radio access network by which the User Equipment is connected to a Core Network to provide packet data communications with a packet network, such as the internet.

The current leading wireless mobile telephony standard, produced by the 3^{rd} Generation Partnership Project (3GPP) is known as Long Term Evolution (LTE) and LTE-Advanced (LTE-A). In LTE, an Evolved Packet System (EPS) offers enhancements including higher data rates by virtue of developments known as Systems Architecture Evolution (SAE, concerning the core network) and LTE concerning the air interface. Together, these developments are known collectively as LTE. LTE Advanced is considered to be a 4G mobile communication system by the International Telecommunication Union (ITU).

LTE uses an improved radio access technology known as Evolved UTRA (E-UTRA), which offers potentially greater capacity and additional features compared with previous standards. Radio access nodes implementing E-UTRA technology networks are known as Evolved NodeBs (eNodeBs or eNBs). eNBs do not require a separate Radio Network Controller (RNC) and they themselves perform handover functionality and radio resource management. Typically, the eNBs providing the Radio Access Network (RAN) are ‘macrocells’ i.e. provided by high power eNBs that serve a large number of users in cell ranges in the order of tens of kilometres. However, the increased data rates offered in particular by 4G technologies are leading to a large increase in the volume of mobile data traffic being carried by 4G networks.

To lower the pressure on the macrocells, small cell base stations such as picocells, femtocells and microcells provide lower power nodes in a radio access network having a shorter range (typically from 10 m to 1-2 km) that are typically positioned in urban settings and in buildings and serve to offload high volumes of mobile traffic away from the microcells to users in a smaller area and extend reach into buildings. In future 4G networks, a multi-layered heterogeneous network of macrocells and small cells self-organise to provide a high capacity and far-reaching network and a seamless user experience of high data rates and connectivity. These future 4G networks will typically have a macrocell eNB base station with a number of small cells with its cell range. To lower the load on the macrocell eNB base station, the small cells communicate directly with a UE.

There is an inherent trade-off between the range and performance of small cell base stations, and the power and specifications (computational power) needed to achieve it. However, any improvements in small cell range or performance that are achievable without a related increase in base station specifications could effectively reduce the infrastructure needed to deploy a small cell layer of a wireless communications network and also increase the effectiveness of the small cell layer, improving user experience and reducing infrastructure costs.

### BRIEF DESCRIPTION OF THE DRAWINGS

The invention, together with objects and advantages thereof, may best be understood by reference to the following description of preferred embodiments together with the accompanying drawings in which:

FIG. 1 shows a message sequence chart setting out the PRACH random access procedure between a UE and a small cell base station;

FIG. 2 shows an example PRACH preamble in format 0;

FIG. 3 shows how the small cell base station signals the cyclic prefix value (N_{CS}) selected from the table to UEs using information elements in a SIB2 BCH message;

FIG. 4 illustrates how, from the perspective of the small cell base station, the position of a preamble peak received from the UE is delayed in the temporal domain by the quantity of propagation delay;

FIG. 5 shows an example eNB process for implementing the dynamic configuration of analysis windows according to an embodiment of the invention;

FIG. 6 illustrates a TOE estimation window and SINR estimation window as dynamically extended in accordance with the present invention;

FIG. 7 shows a conventional wireless communication network in which a macrocell is overlaid with numerous small cells for communication with a UE; and

FIG. 8 is a block diagram illustrating some example components in an example small cell base station that can be used in the LTE-enabled wireless network of FIG. 7 as a small cell base station.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

In one embodiment, the present invention provides a method performed by a base station in synchronizing with a UE in a cell of the base station, comprising: signaling to the UE an indication relating to a subset of preambles chosen for synchronization with the cell from the set of preambles derivable from one or more given root sequences, wherein the subset of preambles is chosen to provide an increased cell radius compared to the cell radius achievable if the specified full set of preambles for random access procedures generated from the given root sequences using a given cyclic shift value.

In another embodiment, a method performed by a base station in a random access procedure for synchronizing with user equipment in a cell of the base station is provided. The method comprises: signaling to a UE an indication relating to a subset of preambles chosen for use in the random access procedure, usable by the UE to randomly select a preamble from the subset, the subset being generated from a given number of root sequences using a cyclic shift value higher than a given cyclic shift value used to generate the specified full set of preambles from the given root sequences.

In another embodiment, the present invention provides a method performed by a base station in a random access procedure for synchronizing with user equipment in a cell of the base station, comprising: signaling to a UE an indication relating to a subset of fewer than 64 preambles chosen for use in the random access procedure, usable by the UE to randomly select a preamble from the subset, the subset being generated from a single root sequence using a cyclic shift value higher than 13.

In yet another embodiment, the present invention provides a method of analyzing a received signal in a physical layer of a base station in a code division multiplexing (CDM) system, comprising: identifying, based on resource allocation and user information, vacant code sequences where no user is present in the system; dynamically adjusting a size of analysis windows for present users to extend them into the vacant code sequences of missing neighboring users; and analyzing a received signal using the dynamically adjusted user analysis windows.

In another embodiment, the present invention provides a small cell base station configured to operate using any of the embodiments of methods described above.

The present invention has been devised pursuant to a recognition that wireless communication standards, in this case the 3GPP 4G/LTE specification, has been devised with macro scenarios in mind (i.e., serving users in cell ranges of 10 km+ at peak user load). Implementing these specifications in small or metro cells does not represent an efficient allocation of resources. In this respect, by configuring the operation of small/metro cell base stations differently to the standard specification to operate or be optimised for the burdens placed on them (e.g., fewer users present in the system), the present invention allows a more efficient allocation of limited small cell power and computation resources to be achieved, allowing small cell base stations to provide increased cell radius and improved performance without any increase in the hardware requirements.

In this regard, a key limitation on cell radius is the random access procedure, PRACH, corresponding to a layer 1 procedure in the OSI model in which a UE transmits a code sequence or signature, known as a preamble, which is typically randomly selected from one of 64 available preambles for a cell (in 4G systems) for detection by a base station which allows the User Equipment to access the cell, achieve timing synchronisation therewith and be allocated radio resources by the base station for uplink and downlink communications.

A full specification of the LTE PRACH process is set out in section 5.7 the technical specification no. 3GPP TS 36.211 V12 entitled “3rd Generation Partnership Project; Technical Specification Group Radio Access Network; Evolved Universal Terrestrial Radio Access (E-UTRA); Physical channels and modulation” in Rel-12 of the LTE specification, and the content of this document is incorporated herein by reference.

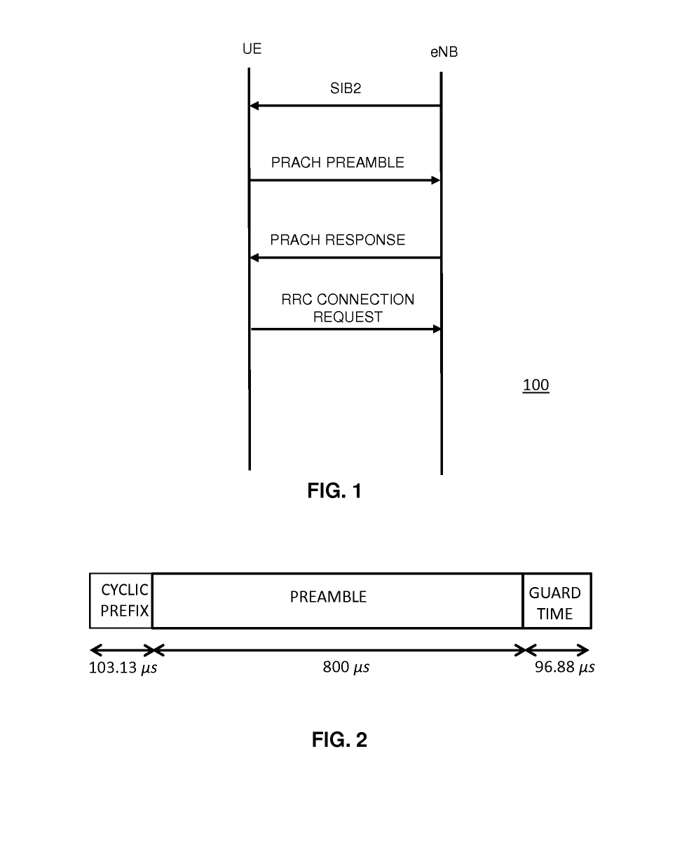

FIG. 1 shows a message sequence chart 100 setting out the PRACH random access procedure between a UE and a base station which may be a macrocell eNB or a small cell. The random access procedure is initiated by the UE by the Layer 3 radio resource control RRC entity sending a request to the UE layer 2 medium access control MAC entity in the following scenarios:

Initial Access when UE is trying to access the network in RRC idle state;

During an RRC connection re-establishment procedure;

On handover

When uplink synchronization is lost due to network having not received anything from UE in uplink for a certain period.

When UE does not have any PUCCH resources available for a SR(Scheduling Request).

When timing advance is needed for positioning purposes in RRC connected state for UE.

First, the UE receives and decodes a System Information Block message SIB2 broadcast by the eNB using the Physical Data Shared Channel (PDSCH) approximately every 160 ms. The SIB2 message includes parameters that enable the UE to connect to the network and a specific cell within the network. The UE will decode the SIB2 message and the UE MAC entity then has information about for example cell bandwidths, whether to use frequency division duplexing FDD or time division duplexing TDD and enough information to be able to access the cell via the random access procedure. Specifically, the parameters contained in the SIB2 message signalled by the eNB are needed to be passed to the UE Physical layer 1 PHY entity to enable the generation of the PRACH preamble to be sent by the UE to the eNB in the next step to enable recognition and resource allocation thereby.

The SIB2 parameters required to generate PRACH preambles are: PRACH root index (i.e., rootSequenceIndex information element) (u-0 to 838); preamble format (0 to 4); high speed flag (0 or 1); zero correlation zone index (i.e., zeroCorrelationZoneConfig information element) (Ncs-0 to 15); PRACH configuration index (0 to 15).

The preambles are generated by the UE based on cyclic shifts of Zadoff Chu Root Sequences. These sequences exhibits the useful property that cyclically shifted versions of itself are orthogonal to one another, provided, that is, that each cyclic shift, when viewed within the time domain of the signal, is greater than the propagation delay (and multi-path delay-spread) of that signal between the transmitter and receiver. As ZC sequences have the constant amplitude zero autocorrelation property, by assigning orthogonal ZC root sequences to each base station cell, the inter-cell interference can be kept low and eNB transmissions can be uniquely identified.

The random access preamble format has a cyclic prefix, a preamble and a guard time during which there is no signal transmitted. The LTE specification provides a set of 64 possible preamble sequences per cell that have to be generated from a number of given root sequences for a given cyclic shift value. The FDD LTE specification defines four different Random Access (RA) preamble formats with different preamble and cyclic prefix duration to accommodate different cell sizes. For example, referring to FIG. 2 an example preamble Format 0 is illustrated. The preamble format 0 is well suited for small to medium size macrocells (up to approximately 14 km) and uses a full 1 ms subframe and has a preamble duration of 800 μs with 103 μs cyclic prefix and 97 μs guard time.

Each UE generates a preamble code sequence having a complex value xᵤ(n) at each position n of each root Zadoff-Chu sequence parameterized by u by the following equation where u=physical root sequence index for the cell set by the rootSequenceIndex information element in the SIB2 message with reference to the table 5.7.2-4 in the LTE 3GPP TS 36.211 V12 and where N_{ZC} is the random access preamble sequence length.

$${x}_{u} ( n ) = {e}^{- j \frac{π un ( n + 1 )}{{N}_{ZC}}} , \\ 0 \leq N \leq {N}_{ZC} - 1$$

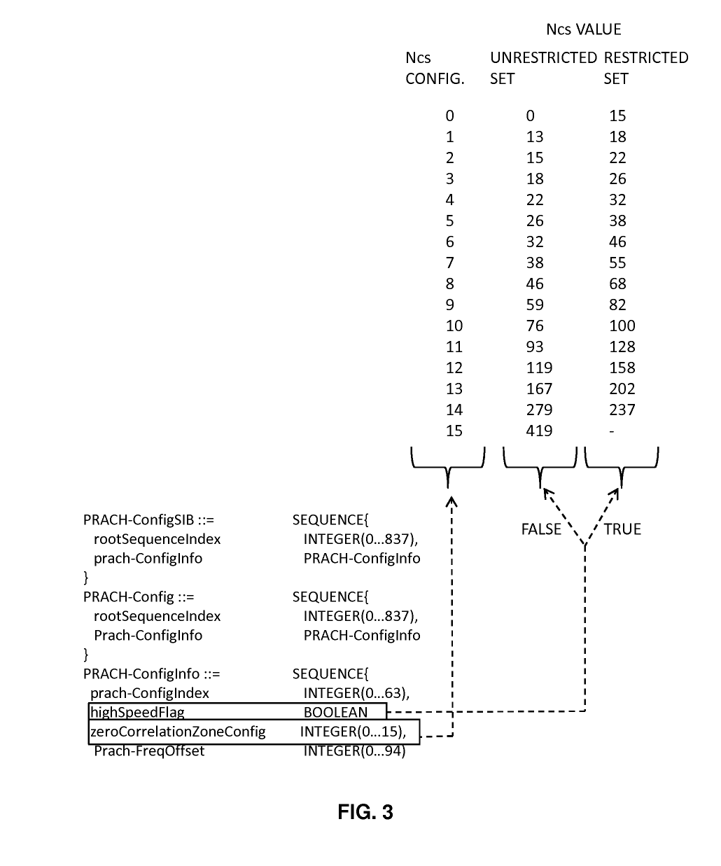

For each UE to be able to generate the 64 preambles for each cell, the above sequence is cyclically shifted by an amount cᵥ signalled by the eNB by the zeroCorrelationZoneConfig information element with reference to the table 5.7.2-2 in the LTE 3GPP TS 36.211 V12. As shown in FIG. 3, the cyclic shift value, cᵥ is set to a prime number chosen to keep all preambles in a cell orthogonal to each other. Depending on whether the SIB2 message sets the highSpeedFlag as True or False, the selection of the cyclic shift based on the zeroCorrelationZoneConfig information element indicating the N_{CS} configuration is selected from the restricted set or unrestricted set. The difference between the two is that cyclic shifts for the restricted set have a Doppler shift factored in to account for high speed cells.

Once the cyclic shift value, cᵥ is known by the UE, the UE can generate any of the 64 preambles in the group using the following formula where N_{ZC} is the random access preamble sequence length, which, for preamble formats 0-3, is 839.

x_{u,v}(n)=xᵤ((n+Cᵥ)mod N_{zc})

where the cyclic shift value, C_{V}, for unrestricted sets is v*N_{CS}, where v=0, 1, . . . , [N_{ZC}/N_{CS}]−1, for N_{CS}≠0.

In the random access PRACH procedure, the UE either selects one of the available preambles at random for contention-based process (where random collision by UEs is permitted) or the UE is signalled by the eNB an assigned preamble to avoid collision.

From the preamble sequence x_{u,v}(n) generated by the root sequence and the cyclic shift, the baseband signal s(t) is generated by the UE according to the formula taken from 5.7.2/5.7.3 of 3GPP TS 36.211.

The random access preambles are transmitted on blocks of 72 contiguous uplink subframe 15 kHz subcarriers allocated for random access by the base station. One subcarrier for the PRACH preamble is 1.25 KHz, twelve of which correspond to one uplink subframe 15 kHz subcarrier. The exact frequency used for transmission of the random access preamble is selected from the available random access channels by higher layers in the UE.

As indicated above, the preambles are orthogonal to one another, provided that each cyclic shift, when viewed within the time domain of the signal, is greater than the propagation delay of that signal between the transmitter and receiver (here, for simplicity, we are ignoring the delay spread). Thus the cyclic shift value places an inherent limit on the cell radius.

Given that the sequence length, for preamble format 0, is 839 and it spans 800 μs, the preamble duration is:

Preamble duration=(Ncs−1)*(800 μs/839 μs)

This needs to be greater than the round trip delay, RTD, from the cell edge to achieve orthogonality between preambles, which is:

RTD=2*Cell Radius (R)/speed of light (c).

Reconciling these two equations, we get the following relation for the max cell radius, R, for a given cyclic shift value Ncs:

R≦[c/2]*[(Ncs−1)*(800/839)]

Where c=speed of light

Thus to achieve a given cell radius, a cyclic shift value needs to be chosen accordingly; the greater the cyclic shift, the larger the radius.

However, as a result of choosing large cyclic shift values, the number of root sequences that are needed to generate the requisite 64 preambles specified in the standard also increases. For example, for a cyclic shift value of 13 (i.e. Ncs config 1), 64 preambles can be produced from a single ZC sequence of length 839. However, for a cyclic shift value of 38 (i.e. Ncs config 7), only 22 preambles can be produced from a single ZC sequence of length 839. As a result, the UE needs three ZC root sequences to generate the specified 64 preambles.

Table 1 below sets out, for Ncs config values up to 7 the cell radius, number of preambles per root sequence and number of root sequences needed to generate 64 preambles.

TABLE 1

| | | Max | | |
|---|---|---|---|---|
| | | cell | Number of | |
| Ncs | Ncs | radius | preambles per | Number of root |
| config | (Cv) | (km) | root sequence | sequences needed |
| 1 | 13 | 1.86 | 64 | 1 |
| 2 | 15 | 2.15 | 55 | 2 |
| 3 | 18 | 2.57 | 46 | 2 |
| 4 | 22 | 3.15 | 38 | 2 |
| 5 | 26 | 3.72 | 32 | 2 |
| 6 | 32 | 4.58 | 26 | 3 |
| 7 | 38 | 5.44 | 22 | 3 |

However, on receiving the PRACH preambles at the eNB, the ability to decode an increased number of root sequences imposes a significant increase in the computational load which leads to a higher hardware specifications being required for the eNB.

As indicated above, the present invention has been devised in recognition that the wireless communication standards have typically been specified with the optimisation of resource allocation for macrocells in mind.

However, in recognition that the resource requirements for small cells are very different in that fewer users will typically be present, in one embodiment, the present invention provides a method of a base station in synchronizing with a user equipment UE in a cell of the base station, comprising: signaling to the UE an indication relating to a subset of preambles chosen for synchronization with the cell from the set of preambles derivable from one or more given root sequences, the subset of preambles being chosen to provide an increased cell radius compared to the cell radius achievable if the specified full set of preambles for random access procedures generated from the given root sequences using a given cyclic shift value.

As will be shown below, by the eNB signaling that UEs should initiate random access procedures therewith using only a selected subset of preambles (e.g., numbering less than 64), the present invention provides for increased cell radius through PRACH accessibility, while at the same time limiting the impact of increased computational or other hardware requirements on the eNB. By providing fewer than the specified number of preambles, there is no impact on user experience as the likelihood of user collisions on PRACH preamble transmission remains low (due to the reduced number of users in a small cell) whereas the cell radius increases, reducing the infrastructure requirements and extending the network coverage.

In embodiments, the subset of preambles may be generated by choosing a cyclic shift value higher than the given cyclic shift value used to generate the specified full set of preambles for random access procedures using the given root sequences. For example, referring to Table 1 above, for an eNB being configured to decode and search preambles generated from two root sequences, the eNB may signal a zeroCorrelationZoneConfig information element value (Ncs config value) of 6 or higher, meaning that a cyclic shift of 32 or higher gives only 52 or fewer preambles are available to the UEs (rather than the specified 64, which would require a cyclic shift value of 26 or lower). By doing this, the cell radius can be increased beyond the 1.86 km maximum that would be achieved if 64 preambles were used, without any appreciable detrimental impact on user experience, or any increased demands on computational power of the eNB.

Thus, in one embodiment, the present invention provides a method performed by a base station in a random access procedure for synchronizing with user equipment in a cell of the base station, comprising: signaling to a UE an indication relating to a subset of preambles chosen for use in the random access procedure, usable by the UE to randomly select a preamble from the subset, the subset being generated from a given number of root sequences using a cyclic shift value higher than a given cyclic shift value used to generate the specified full set of preambles from the given root sequences.

In embodiments, the number of given root sequences may be 1 and optionally the cyclic shift value may be greater than 13. In embodiments, the number of preambles generateable from the given root sequences using the cyclic shift value for generating the subset of preambles is preferably fewer than 64.

In embodiments, the eNB practically achieves this reduced number of preambles and increased cell radius by signaling to the UE an SIB2 message signaling:
a value for the zeroCorrelationZoneConfig information element corresponding to the cyclic shift value for generating the subset of preambles;
a value for the rootSequenceIndex information element corresponding to at least the first of the given root sequences; and
a value for the numberOfRA-Preambles information element to cause the preamble selection to be limited to the chosen subset of preambles generated from the given root sequences.

The invention is in the L2/L3 (Higher layers) and L1 (Physical layer) of the eNodeB software components. Also, this includes the eNB configuring the LTE UE in a way to ensure extended cell range. An example process for achieving this will now be described.

For example, first, higher layers of LTE stack (LTE L2/L3) configure the eNB Physical layer (PHY aka L1) software for extended cell range over the L1/L2 Femto API interface.

Then, the eNB L1 configures its Random Access Channel (PRACH) modules for extended cell range. In order to not increase the existing computation load of the PRACH module in the L1, the number of root sequences is limited to, e.g., 1 by the eNB L1 software. As noted above, the total number of available preambles is derived from the root sequence and Ncs value which in turn is dependent on Zero Correlation Zone (ZCZ). Eg: with ZCZ=7, extended cell radius of 5.4 KM is achieved but available preambles is reduced to 22 preambles out of max 64 for ZCZ=7 as derived from 3GPP LTE specification.

The eNB L2/L3 then informs the UEs that only limited preambles supportable by 1 root sequence are available for PRACH as per 3GPP spec 36.212. So UE will also choose preambles from 1 root sequence only for synchronizing UL with the eNodeB

The L2 Random Access Preamble configuration broadcast mechanism by eNB in order to configure UEs for extended range is shown below taking ZCZ=7 as an example. The SIB2 information elements indicated below are set as follows. For ZCZ=7 (i.e. NCSconfig index=7), the total number of available preambles for 1 root sequence=22 (from table in previous slide).

Information element zeroCorrelationZoneConfig is set to 7.

Information element numberOfRA-Preambles is set to 20. Thus 20 of the 22 available preambles are reserved for contention based random access preambles that UEs can randomly select. The Remaining 2 preambles are reserved for non-contention based random access preambles

Information element sizeOfRA-PreamblesGroupA is set to 16. Out of 20 preambles, 16 preambles (0 . . . 15) are reserved when UEs have small RACH message size to transmit; this is called Random Access Preamble group A. The remaining 4 preambles (16 . . . 19) are reserved when UEs have large RACH message size to transmit; this is called Random Access Preamble group B.

Information element messageSizeGroupA is set to 256 bits. Indicates that the message size for Group A is 256 bits.

Information element preambleTransMax is set to 10. Thus the maximum number of preamble transmissions is set to 10 so that the UEs that experiences a preamble collision can retry after a back-off time with another preamble and succeed in accessing the network.

Alternatively, or in addition to the above, the subset of preambles may be generated by choosing from a set of preambles derivable for a given cyclic shift value preambles one or more of which are spaced apart from other preambles of the subset. In this way, the number of root sequences need not necessarily be restricted in order to produce the subset of preambles for use in the cell to increase cell radius. Rather, the subset of preambles may be chosen from the 64 (or fewer) available from the given root sequences by selecting preambles to have spaces therebetween. Thus the preambles may be chosen by selecting alternate preambles from the given ZC root sequences for a given cyclic shift. This may be selected to provide fewer than 64 preambles. For example, by selecting every other preamble, a subset of 32 preambles is chosen. It is important to note here that the increase in cell radius is achieved not because of any increase in cyclic shift value (although this may be used as well) but due to the spacing between preambles allowing the small cell base station to extend its analysis window for code sequence detection. As will be explained below, this allows a greater range for timing offset estimation, and thus an increased cell range as a greater range of propagation delays for PRACH preambles can be reliably detected.

Normally, at the eNB, on reception of the PRACH preambles from users present in the system, a search is conducted for the present users by correlating the received preambles with all 64 non-spaced preambles of the full set that can be generated by the given cyclic shift value and given ZC root sequences. If the received preamble is matched with one in the set, then it will give maximum correlation magnitude. A detection threshold will be set, based on a noise floor and false alarm probability. The fact that different PRACH signatures are generated from cyclic shifts of a common root sequence means that the frequency-domain computation of the Power Delay Profile (PDP) of a root sequence provides in one shot the concatenated PDPs of all signatures derived from the same root sequence.

The noise-floor threshold function collects the PDP output and estimates the absence or presence of a preamble by predefined threshold level. If the noise-floor threshold function detects the existence of RA preamble in received signal, the peak searching function estimates the preamble ID and propagation delay.

Due to the unique correlation properties of ZC sequence as described previously, the preamble ID can be indicated by the peak position information and its cyclic shift value, C_{V}. If the preamble is received with a certain amount of propagation delay, the peak position information is effected by not only C_{V} but also the amount of delay.

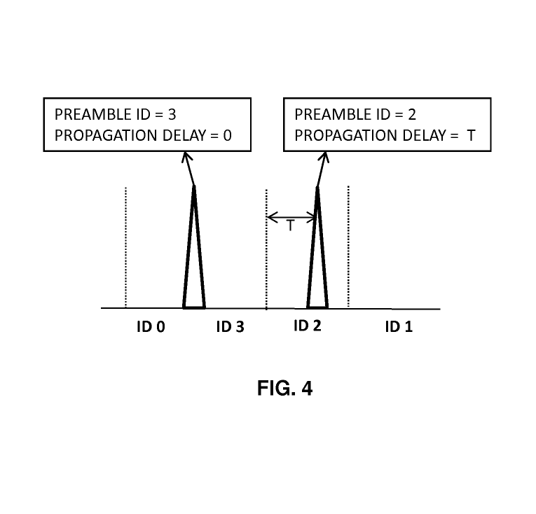

As illustrated in FIG. 4, the position of the peak is delayed in temporal domain by the quantity of propagation delay. According to this, the preamble detection routine can estimate Preamble ID and its propagation delay exactly if the quantity of propagation delay in time domain is less than unit cyclic shift value. The searching window is therefore limited to around the propagation delay in time domain being less than unit cyclic shift value—corresponding to the cell size.

Therefore, the signature detection process normally consists of searching, within each zero correlation zone defined by each cyclic shift, the PDP peaks above a detection threshold over a search window corresponding to the cell size. Thus the cell size is effectively limited by the range of the timing offset estimation (TOE) window.

In the present invention, by leaving spaces between the preambles, the searching window for the position of preamble peaks delayed due to a propagation delay can be extended into the gaps between the preambles. By allowing extension of the search window, this has the effect of increasing the range of detectable preamble peaks (i.e. increasing the TOE range) and thus increasing the cell size. As we will show below, experiments have shown that, for the same cyclic shift value, the use of a subset of preambles for PRACH having spaces between them and configuring the eNB to have an extended analysis window, can double the cell radius. This is achieved with no negative impact on user experience or implications for improvements to the hardware or computational power specification of the eNB.

In embodiments, the method may therefore further comprise: analyzing a received signal using analysis windows configured to be extended in length to encompass spaces in the cyclic shifts between the preambles of the subset.

The timing offset estimation range and SINR estimation range may be extended based on the extended analysis windows.

In embodiments, the method may further comprise: dynamically configuring, based on obtained allocation and user information, analysis windows of users present in the system to extend those analysis windows to encompass spaces in the cyclic shifts between neighboring users present in the system. By dynamically extending the analysis window, the range can be extended even further based on whether or not neighboring users are present in the system, using allocation and user information obtained from higher layers.

In embodiments, information pertaining to the extended analysis windows can be stored in a lookup table. The lookup table may be dynamically revised based on obtained allocation and user information.

The method may further comprise dynamically allocating a user to an extended analysis window, wherein the signaling to the UE comprises assigning the user to the preamble corresponding to the extended analysis window. The dynamic allocation of a user to an extended analysis window may occur if the timing offset or SINR of the user cannot be reliably estimated.

In fact, the above invention of choosing a subset of spaced code sequences may be applied not just to PRACH random access procedures to increase cell radius, but to all code division multiplexing procedures to provide attendant advantages.

For example, in LTE, ZC root sequences are used also in the following procedures: Primary Synchronization Signal (PSS), uplink control channel (PUCCH), uplink traffic channel (PUSCH) and sounding reference signals (SRS).

In particular, by the eNB spacing code sequences in the above CDM procedures, the analysis windows for the received code sequences can be extended in particular to extend the timing offset estimation range and SINR estimation range. This improves the reliability of received signal performance-metrics-computation in the presence of timing errors. This improves the system stability in the presence of timing offsets, and improves the reliability of the estimation of channel state parameters. This also improves the effective data throughput by estimating received SINR properly to help modulation and coding scheme (MCS) selection at the transmitter end of the eNB. This also provides the ability to detect timing offsets even if the users delay or advance exceeds the user analysis window length.

The configurable analysis window may be beneficially implemented even where the code sequences available are not prescribed in the system to have spaces therebetween by identifying missing users and dynamically adjusting the analysis window sizes for present users to extend them into vacant neighbouring spaces.

Thus, in one embodiment, the present invention provides a method of analyzing a received signal in a physical layer of a base station in a code division multiplexing (CDM) system, comprising: identifying, based on resource allocation and user information, vacant code sequences where no user is present in the system; dynamically adjusting a size of analysis windows for present users to extend them into the vacant code sequences of missing neighboring users; and analyzing a received signal using the dynamically adjusted user analysis windows. The timing offset estimation range and SINR estimation range are extended based on the extended analysis windows.

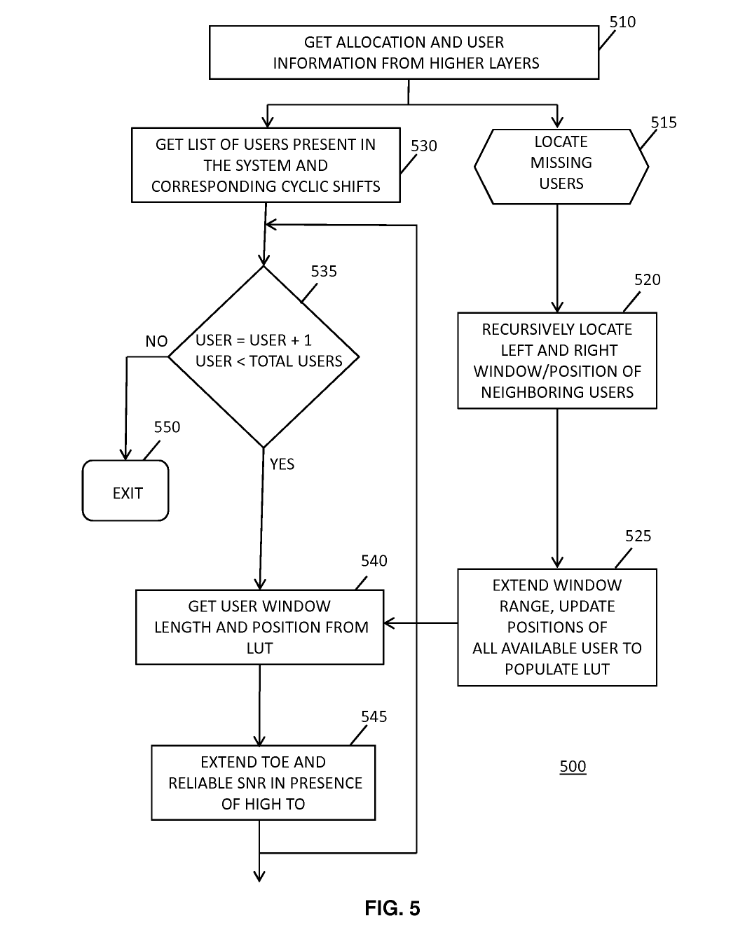

According to an embodiment of the invention, an eNB process 500 for implementing this dynamic configuration of analysis windows based on vacant user will now be described with reference to the process flow chart shown in FIG. 5. The process may be operated continuously or periodically.

First, in block 510, the resource allocation and user information is received from higher layers.

Next, in the right hand arm of the parallel process, in block 515, missing users are located (e.g., periodically) by identifying vacant code sequences where no user is present in the system. Here cyclic shifts used for the code sequence that correspond to missing users are identified. Then, in block 520, The extrema of the analysis windows (e.g., TOE and SINR estimation windows) are then recursively located by extending them into the gaps between the code sequences where no user is present. Information pertaining to the extended analysis windows is then stored in a lookup table in block 525. The lookup table may be dynamically revised based on obtained allocation and user information.

On the left hand branch, in block 530, the users present in the system and their corresponding cyclic shifts are retrieved. For each user present in the system (counted in decision block 535), the extended analysis window range and position is then retrieved in block 540 from the look up table and the received signal is thus analyzed based on these extended windows to give an extended timing offset estimation and a reliable SINR estimation, even in the presence of a high timing offset. At block 545, where a user is present at a high timing offset, the timing offset estimation window and SINR estimation window are extended. At block 550, the process dynamic process exits once all users have been processed.

A user may be dynamically allocated to an extended analysis window, for example by signaling a preamble allocation in a contention-free random access procedure. The signaling to the UE comprises assigning the user to the preamble corresponding to the extended analysis window. The dynamic allocation of a user to an extended analysis window may occur, for example, if the timing offset or SINR of the user cannot be reliably estimated.

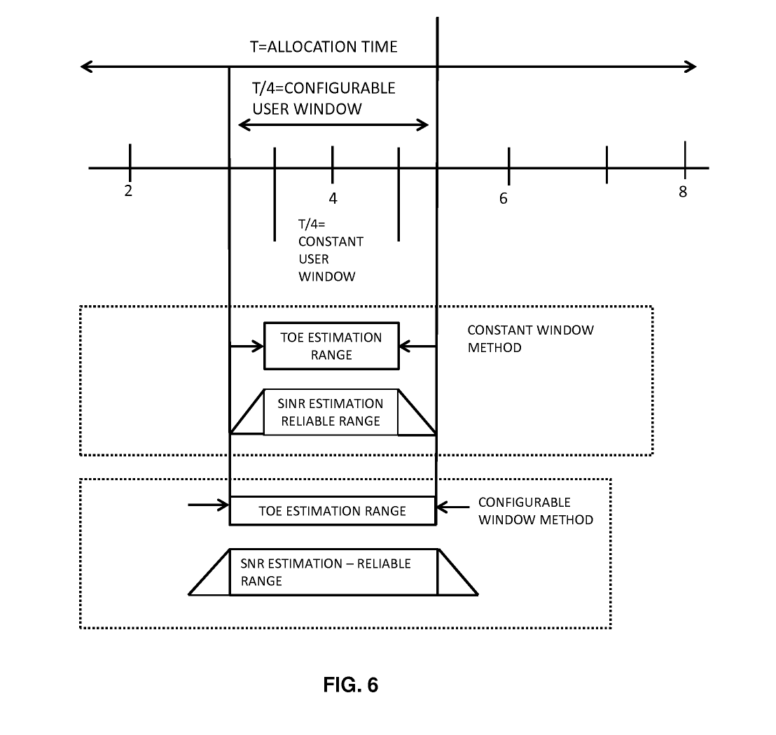

FIG. 6 illustrates the TOE estimation window and SINR estimation window provided in a conventional constant windowing method (top) compared to an extended TOE estimation window and an extended SINR estimation window achievable through the configurable window method (bottom).

The above configurable analysis window method has been implemented in a small cell base station for analysis of the CDM sounding reference signals (SRS) received from users present in the system.

The experimental system configuration was as follows: 1 allocation with 4 UEs. In this experiment, 4 UEs were assigned (using CDM) in an allocation with a timing offset of 6 TA (1 TA=0.52 us) and the following observations were made.

Without applying the dynamic analysis window configuration method of the present invention, at eNodeB, the receiver failed to detect timing offset (TO), frequency offset (FO) due to Doppler affect and computed SINR was erroneous.

With the application of the dynamic analysis window configuration method of the present invention, L2 was configured such that it allowed users to be apart during CDM and hence the receiver could leverage the extended window for analysis. In this case, the receiver could detect timing offset (TO) and frequency offset (FO) correctly and computed SINR was close to the received signal SINR.

These findings were verified in simulation (MATLAB Tool) and confirmed in lab trials, which show that as a result of the above method, extended (double) cell coverage is achieved for RACH application without changing zero correlation zone index.

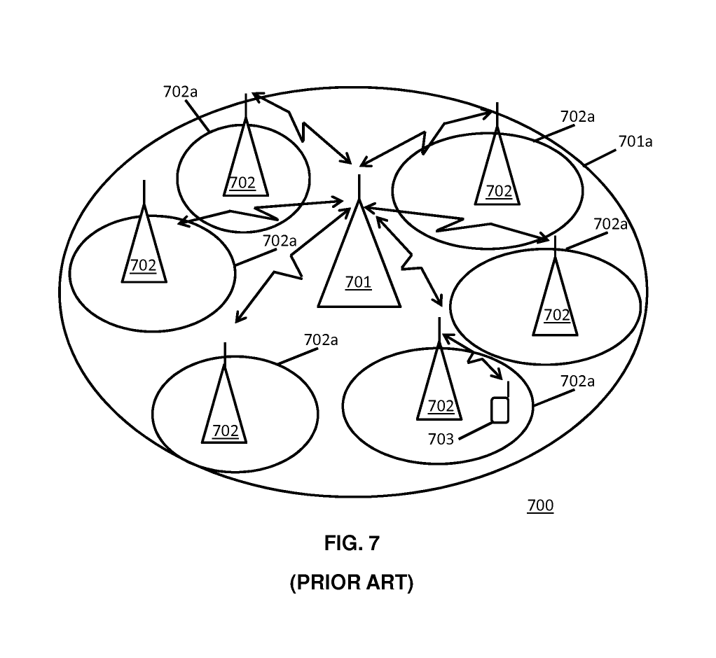

FIG. 7 shows a conventional wireless (cellular) communication network 700 in which a macrocell eNB base station 701 has, within its cell range 701a, a number of small cells 702. The small cells 702 each have a respective small cell range 702a that communicate directly with a user equipment (e.g. smartphone) 703 in their respective cell ranges to thereby lower the load on the macrocell eNB base station 701.

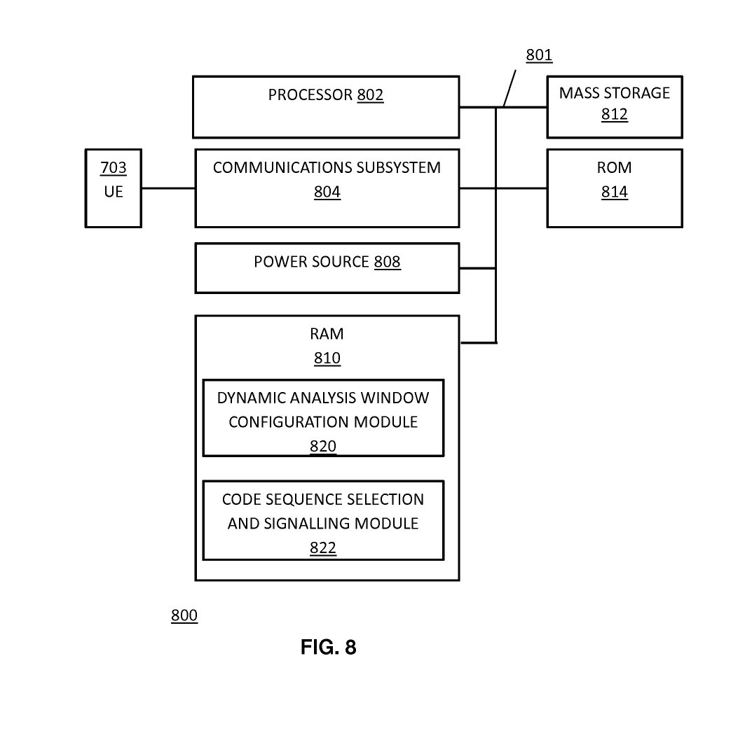

FIG. 8 is a block diagram illustrating some example components of an example small cell base station 800 that can be used in the LTE-enabled wireless network shown in FIG. 7 as a small cell base station 702 to communicate with a UE 703 in accordance with embodiments of the invention. The small cell base station 800 includes multiple components linked by a communications bus 801. A processor 802 controls the overall operation of the small cell base station 800. Communication functions, including handling of upstream and downstream user plane data and voice communications, and control plane data communications, are performed through a communication subsystem 804. The communication subsystem 804 in this embodiment in particular provides a transceiver operating in accordance with the LTE/LTE Advanced wireless communication standard as defined by 3GPP. In embodiments, the communication system may alternatively or in addition include modems, modem banks, Ethernet devices, universal serial bus (USB) interface devices, serial interfaces, token ring devices, fibre distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. The communication subsystem 804 enables the processor 802 to communicate with the UE 703 or one or more telecommunications networks or other networks from which the processor 802 might receive information or to which the processor 802 might output information.

In the context of FIG. 7, the communication subsystem 804 receives messages from and sends messages to UE 703 shown in FIG. 7 for voice communications or data communications or both.

A power source 808, such as a port to an external power supply, powers the small cell base station 800.

The processor 802 interacts with other components of the electronic device including Random Access Memory (RAM) 810, mass storage 812 (including but not limited to magnetic and optical disks, magnetic tape, solid state drives or RAID arrays) and Read Only Memory (ROM) 814.

The processor 802 executes instructions, code, software or computer programs it may access from communications subsystem 804, RAM 810, mass storage 812 or ROM 814. The processor 802 may comprise one or more data processing units or CPU chips. The processor 802 may execute the instructions solely by itself, or in concert with other locally or remotely provided data processing components or other components not shown in FIG. 8. In particular, the processor 802 is capable of carrying out instructions such that the UE 800 is operable to perform wireless communications in an LTE network in accordance with the disclosure set out herein.

For example, the processor 802 may carry out instructions, for example, mass storage 812 and/or ROM 814, to instantiate and maintain a dynamic analysis window configuration module 820 in RAM 810 that in use causes the small cell base station 800 to operate the method described herein in reference to FIG. 5. Similarly, the processor may carry out instructions stored in, for example, mass storage 812 and/or ROM 814, to instantiate and maintain a code sequence selection and signalling module 822 in RAM 810 that in use causes the small cell base station 800 to select the code sequences for use by UEs in communicating with the base station, for example in order to extend the cell radius or improve the timing offset estimation or SINR estimation, as described herein. The code sequence selection and signalling module 822 also causes the small cell base station 800 to perform signaling such that the UEs in the small cell use the selected code sequences, as described herein. The code sequences that are then received at the communication subsystem 804 the from UE 703, are in accordance with the signaled and selected code sequences for the following processes: Primary Synchronization Signals (PSS), random access preamble (PRACH), uplink control channel signals (PUCCH), uplink traffic channel signals (PUSCH) or sounding reference signals (SRS).

Thus, the invention extends to small cell base stations configured to operate the any of the embodiments set out above. The UE 703 may be standard smartphone, such as an LTE compliant smart phone.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A method performed by a base station in synchronizing with a user equipment (UE) in a cell of the base station, comprising:
signaling to the UE an indication relating to a subset of preambles chosen for synchronization with the cell from the set of preambles derivable from one or more given root sequences, wherein the subset of preambles is chosen to provide an increased cell radius compared to the cell radius achievable if the specified full set of preambles for random access procedures was generated from the given root sequences using a given cyclic shift value.

2. The method of claim 1, wherein the subset of preambles is generated by choosing a cyclic shift value higher than the given cyclic shift value used to generate the specified full set of preambles for random access procedures using the given root sequences.

3. The method of claim 1, wherein the number of given root sequences is one and optionally wherein the cyclic shift value is greater than 13.

4. The method of claim 1, wherein the number of preambles that can be generated from the given root sequences using the cyclic shift value for generating the subset of preambles is less than 64.

5. The method of claim 1, wherein the signaling to the UE includes sending an SIB2 message signaling including:
a value for the zeroCorrelationZoneConfig information element corresponding to the cyclic shift value for generating the subset of preambles;
a value for the rootSequenceIndex information element corresponding to at least the first of the given root sequences; and
a value for the numberOfRA-Preambles information element to cause the preamble selection to be limited to the chosen subset of preambles generated from the given root sequences.

6. The method of claim 1, wherein the subset of preambles is generated by choosing from a set of preambles derivable for a given cyclic shift value preambles one or more of which are spaced apart from other preambles of the subset.

7. The method of claim 6, further comprising:
analyzing a received signal using analysis windows configured to be extended in length to encompass spaces in the cyclic shifts between the preambles of the subset.

8. The method of claim 6, further comprising:
dynamically configuring, based on obtained allocation and user information, analysis windows of users present in the system to extend said analysis windows to encompass spaces in the cyclic shifts between neighboring users present in the system.

9. The method of claim 8, wherein the timing offset estimation range and Signal to Interference plus Noise Ratio (SINR) estimation range are extended based on said extended analysis windows.

10. A method performed by a base station in a random access procedure for synchronizing with user equipment in a cell of the base station, comprising:
signaling to a user equipment (UE) an indication relating to a subset of preambles chosen for use in the random access procedure, usable by the UE to randomly select a preamble from the subset, wherein the subset is generated from a given number of root sequences using a cyclic shift value higher than a given cyclic shift value used to generate the specified full set of preambles from the given root sequences.

11. A method of analyzing a received signal in a physical layer of a base station in a code division multiplexing (CDM) system, comprising:
identifying, based on resource allocation and user information, vacant code sequences where no user is present in the system;
dynamically adjusting a size of analysis windows for present users to extend the present users into the vacant code sequences of missing neighboring users; and
analyzing a received signal using the dynamically adjusted present user analysis windows.

12. The method of claim 11, wherein the resource allocation and user information is received from higher layers.

13. The method of claim 11, wherein identifying vacant code sequences where no user is present in the system comprises identifying cyclic shifts used for the code sequence that correspond to missing users.

14. The method of claim 11, wherein information pertaining to the extended analysis windows is stored in a lookup table.

15. The method of claim 14, wherein the lookup table is dynamically updated based on obtained allocation and user information.

16. The method of claim 11, further comprising dynamically allocating a user to an extended analysis window, wherein the signaling to the UE comprises assigning the user to the preamble corresponding to the extended analysis window.

17. The method of claim 16, wherein the dynamic allocation of a user to an extended analysis window occurs if the timing offset or Signal to Interference plus Noise Ratio (SINR) of the user cannot be reliably estimated.

18. The method of claim 11, wherein the code sequences are based on cyclic shifted Zadoff-Chu root sequences.

19. The method of claim 18, wherein the code sequences are received from User Equipment as Primary Synchronization Signals (PSS), random access preamble (PRACH), uplink control channel signals (PUCCH), uplink traffic channel signals (PUSCH) or sounding reference signals (SRS).

20. The method of claim 11, wherein the analysis windows comprise a timing offset estimation window and/or a Signal to Interference plus Noise Ratio (SINR) estimation window.
